(19) United States
(12) Patent Application Publication
(10) Pub. No.: US 2015/0320640 A1
(43) Pub. Date: Nov. 12, 2015

(54) Method of Manufacturing a Medical Device

(71) Applicant: Novo Nordisk Healthcare AG, Zurich (CH)

(72) Inventor: Ulla Holm Christensen, Saeby (DK)

(21) Appl. No.: 14/409,127

(22) PCT Filed: Jul. 2, 2013
(86) PCT No.: PCT/EP2013/063894

§ 371 Date: Dec. 18, 2014

Related U.S. Application Data
(60) Provisional application No. 61/667,514, filed on Jul. 3, 2012.

(30) Foreign Application Priority Data
Jul. 2, 2012 (EP) 12174592.1

(51) Int. Cl. A61J 1/20; B65B 55/02; B65B 3/00

(52) U.S. Cl. CPC A61J 1/2048; B65B 3/003; B65B 55/027; A61J 1/201; A61J 1/2089

(57) ABSTRACT

The invention relates to a method of manufacturing a medical device (1, 299, 399), the method comprising: (i) receiving in a first cleanroom environment categorised by a first airborne particulate cleanliness a plurality of medical components (10, 20, 50, 50′, 210, 220, 320, 350) prepared in a second cleanroom environment categorised by a second airborne particulate cleanliness, which is higher than the first airborne particulate cleanliness, where each of the plurality of medical components (10, 20, 50, 50′, 210, 220, 320, 350) comprises a sealed surface portion, (ii) assembling at least the plurality of medical components (10, 20, 50, 50′, 210, 220, 320, 350) in the first cleanroom environment, thereby providing a sub-assembly, and (iii) establishing an enclosure for the sub-assembly capable of maintaining an internal airborne particulate cleanliness equivalent to the first airborne particulate cleanliness.

### FIELD OF THE INVENTION

The present invention relates to the manufacturing of medical devices, particularly to the manufacturing of medical devices comprising one or more aseptic surface portions.

### BACKGROUND OF THE INVENTION

When performing a medically related activity that involves the introduction of a foreign object into the body of a subject, it is paramount to use sterile equipment in order to avoid infection. For example, when administering a parenteral drug intravenously both the drug product and the infusion set through which it is delivered should be sterile to eliminate the risk of bloodstream contamination.

Some pharmaceutical drugs adapted for parenteral administration are only stable in the administrable form a relatively short period of time. For convenience reasons, and in order to extend the shelf life of such a drug, it is sometimes preferred to store individual constituents of the drug separately and to mix them only just before a dose is needed.

Traditionally, a mixing of two substances stored in separate vials is performed using a syringe with a needle to withdraw the substance from the one vial and inject it into the other. The syringe with the attached needle is then used to withdraw from the latter vial the desired amount of mixture to be injected into the patient. For example, in case of the reconstitution of a lyophilised drug in a vial, the subject user may withdraw a solvent from a solvent vial, using a conventional syringe with a needle, and inject it into the drug vial to thereby obtain an administrable product which is then withdrawn into the syringe for subsequent administration.

Because the mixing procedure involves a manual handling of the individual components in an environmentally often uncontrolled setting, and the injectable medium is transferred between vials by a syringe with a needle in a procedure that typically includes penetration of two rubber septa in order to establish fluid connection to the respective vial interiors, sterility may be compromised. To reduce the risk of contamination of the administrable substance users are customarily recommended to wear sterile gloves and to clean the respective rubber septa with an alcohol swab before needle penetration. This is, however, often considered a hassle by the user (especially if she/he needs to mix the substances and administer the resulting drug quickly to avert a serious situation), and the precautionary measures are therefore prone to neglection. Seen from a safety perspective, the above described traditional procedure is less than optimal, and in that respect it is desirable to provide a solution which offers lower risk of drug contamination.

U.S. Pat. No. 5,466,220 (Bioject Inc.) discloses a drug mixing and transfer device comprising a vial containing a powdered drug and a syringe filled with sterile water, pre-assembled and packaged in a flexible protective bag that provides for a sealed sterile system. Before use the vial is supported by a piercing connector in a distance from a piercing cannula. It is the intention that the drug mixing and transfer device remains within the sterile packaging until the vial is pushed into the piercing connector, whereby fluid communication is established to the syringe.

While this system may offer a solution which diminishes the potential of contamination because it is sealed during the entire reconstitution process, the system is rather costly to produce due to the need for assembly and packaging of the constituent parts in a so-called ‘critical area’, a controlled environment characterised by an extremely high level of air cleanliness.

U.S. Pat. No. 6,883,222 (Bioject Inc.) concerns a method of manufacturing a drug cartridge assembly which involves the use of a first cleanroom for certain initial pre-sterilisation steps and a second cleanroom of substantially lower particulate-per-volume rating for subsequent post-sterilisation steps, including filling and sealing the drug cartridge.

While this method acknowledges the attractiveness of using cleanrooms of different particulate-per-volume ratings during the manufacturing of a drug cartridge assembly it fails to provide a cost reducing solution for the post-sterilisation part of a medical device production.

### SUMMARY OF THE INVENTION

It is an object of the invention to eliminate or reduce at least one drawback of the prior art, or to provide a useful alternative to prior art solutions.

In particular, it is an object of the invention to provide a method of manufacturing a medical device which is cost-efficient in the use of cleanroom resources.

It is another object of the invention to provide a method of manufacturing a medical device which results in a safe device, offering a reduced risk of contamination of body entering objects, such as e.g. medicinal fluids, compared to traditional handling procedures.

In the disclosure of the present invention, aspects and embodiments will be described which will address one or more of the above objects and/or which will address objects apparent from the below disclosure as well as from the description of exemplary embodiments.

Various processes in the medical device and pharmaceutical industries require a strict control of airborne particles. For example, air in the immediate proximity of exposed sterilised containers or closures, or filling/closing operations, is of acceptable particulate quality only when it meets certain requirements to the concentration of particles within specified particle size ranges.

Internationally, a large number of cleanroom standards classify air cleanliness in controlled environments. International Standard ISO 14644-1 and EU-GMP Guide Annex 1 are examples of such standards which provide different graduations for certain comparable particle sizes. In principle, however, the various standards provide more or less corresponding guidance. Thus, the above mentioned requirements to the concentration of particles are met according to the classification assigned by International Standard ISO 14644-1 in a Class 5 area, whereas they are met according to the EU-GMP Guide Annex 1 in a Grade A area. These areas constitute aseptic manufacturing environments.

Regardless of the specific cleanroom standard the requirements for medical device and pharmaceutical manufacturing of sterile products occasions costly production setups due to the need for preparation and execution of essential processes in ‘critical areas’ that are expensive to use and maintain.

In an aspect of the invention, a method of manufacturing a medical device is provided, the method comprising: (i) receiving in a first cleanroom environment categorised by a first airborne particulate cleanliness a plurality of medical components prepared in a second cleanroom environment categorised by a second airborne particulate cleanliness, which is higher than the first airborne particulate cleanliness, where each of the plurality of medical components comprises a sealed surface portion, (ii) subsequent to step (i) assembling at least the plurality of medical components in the first cleanroom environment, thereby providing a sub-assembly, and (iii) subsequent to, or simultaneously with, step (ii) establishing an enclosure for the sub-assembly capable of maintaining an internal airborne particulate cleanliness equivalent to the first airborne particulate cleanliness.

In the present context the term “a sealed surface portion” designates a hermetically enclosed surface. Hence, each of the plurality of medical components comprises a surface portion which is hermetically enclosed when entering the first cleanroom environment so as to ensure a local environment for that particular surface portion having an airborne particulate cleanliness which equals (or substantially equals in that it is at least as high as) the second airborne particulate cleanliness. One or more of the sealed surface portions may be adapted to become at least somewhat exposed during use of the medical device, e.g. by removal or penetration of the respective seal.

By this method of providing a medical device the constituent plurality of medical components may be sterilised, or otherwise treated, and handled individually in a high grade clean area and then subsequently both assembled and packaged in a lower grade clean area without compromising the cleanliness, e.g. the sterility, of specific surface portions obtained in the high grade clean area. Thereby, the number of process steps and the time spent in the more expensive cleaner environment may be reduced, enabling a significant cost reduction in the production setup. The cost reduction is especially pronounced if the second cleanroom environment is an aseptic environment and the first cleanroom environment is a non-aseptic environment.

It is noted that the enclosure for the sub-assembly established in step (iii) does not necessarily enclose the entire sub-assembly. In some embodiments of the invention only a portion of the sub-assembly is hermetically enclosed.

Since step (iii) is performed in the first cleanroom environment and provides a closed internal environment for at least a portion of the sub-assembly which is at the level of the first cleanroom environment the overall cleanliness of the enclosed portion of the medical device is higher than the cleanliness of the plurality of medical components would be if they were exposed to a non-classified environment during a normal handling procedure. The enclosure established in step (iii) may allow operation of at least some parts of the sub-assembly, and the medical device may thus provide a safer option for the user than traditional procedures because the risk of contamination from human handling in a non-controlled environment is eliminated, or at least markedly reduced.

One or more of the plurality of medical components may enter the first cleanroom environment immediately upon leaving the second cleanroom environment, or following passage through an intermediate grade clean area. Alternatively, one or more of the plurality of medical components may enter a lower grade clean area, or even a non-classified area, before entering the first cleanroom environment, in which case the medical component(s) in question may be protected by being arranged in a (respective) removable sealed enclosure(s) capable of maintaining an internal airborne particulate cleanliness equivalent to the second airborne particulate cleanliness before leaving the second cleanroom environment.

In the present context the term “cleanroom environment” designates a dedicated space in which the concentration of airborne particles is controlled and is meant to encompass both a confined clean space and an open clean zone, such as e.g. obtainable under a laminar flow hood.

Further, in the present context, the term “medical component” designates a non-fluid component, such as a mechanical or electromechanical element or assembly, which is capable of performing a medically related operation (e.g. measuring a body parameter), which is adapted for bodily contact in connection with a medically related operation, or which contains or is otherwise adapted for direct contact with a body fluid or a drug substance (or an ingredient thereof).

In particular embodiments of the invention the second airborne particulate cleanliness is at least 1000 times higher than the first airborne particulate cleanliness. This would for example correspond to a second cleanroom environment meeting the requirements to a Grade A area and a first cleanroom environment meeting the requirements to a Grade C area.

The plurality of medical components may have been prepared in the same cleanroom environment, e.g. in the same particular cleanroom. However, the plurality of medical components may alternatively have been prepared in different cleanroom environments, each of which being characterised by a higher airborne particulate cleanliness than the first airborne particulate cleanliness.

The method may further comprise preparing the plurality of medical components in the second cleanroom environment prior to step (i). The preparation may comprise sterilising and sealing said surface portion of each of the plurality of medical components. Thereby, an aseptic local environment for each of the specific surface portions may be provided, which local environment is maintained when the respective medical components are relayed to the first cleanroom environment.

The sub-assembly provided in step (ii) may be a functional sub-assembly, i.e. an assembly of components forming part of the medical device, wherein at least some of the components are adapted to interact during use of the medical device to produce, or to contribute to the production of, a certain result.

Specifically, step (ii) may provide a sub-assembly wherein at least some of the plurality of medical components are inter-displaceable, thereby enhancing the operability of the medical device. In some embodiments of the invention step (ii) provides a sub-assembly wherein the at least some of the plurality of medical components are inter-displaceable in a pre-defined manner, e.g. along a pre-defined route, ensuring a fail-safe operation of the medical device.

Step (iii) may comprise providing an at least partially dimensionally stable housing for the sub-assembly. The housing may comprise more than one part, in which case at least a portion of one of the parts of the housing is dimensionally stable. In particular embodiments of the invention, the housing comprises a plurality of dimensionally stable parts.

In the present context, the term “dimensionally stable” is used to characterise a structure, or a portion of a structure, whose dimensions remain constant, or substantially constant, when a person's hand applies a (non-destructive) force thereto.

In some embodiments of the invention at least one part of the housing comprises a molded plastic component.

Step (iii) may further comprise sealing the housing to provide an air-tight medical device, thereby fluidly separating the interior of the medical device, comprising the sub-assembly, from its surroundings.

The housing may comprise a first part and a second part being displaceable relative to one another, such as a cover member being removably attachable to a base member, e.g. via a screw-thread connection. This will allow a user to get easy access to the sub-assembly, or a part of the sub-assembly, for operation thereof, by a simple handling of the two housing parts, e.g. a simple twisting action.

One of the first part and the second part may be operatively coupled with the sub-assembly to cause a relative motion between at least two of the plurality of medical components in response to the first part and the second part being displaced relative to one another. This enables a user to operate the sub-assembly without exposing the medical device interior to the surroundings.

In particular, at least a portion of one of the first part and the second part may be dimensionally stable and structured for interaction with the sub-assembly in response to a relative displacement between that portion and the other of the first part and the second part. Thereby, a firm and reliable interaction between the housing part and the sub-assembly is ensured.

In some embodiments of the invention a cover member, e.g. a protective cap, is removably attachable to a cover receiving portion of another housing part or of the sub-assembly and configured to interact with a portion of the sub-assembly at least during detachment from the cover receiving portion. This provides for an automatic pre-operation of the sub-assembly during a manual handling that will eventually lead to an exposure of the sub-assembly, or of a portion of the sub-assembly, for further operation thereof.

The sub-assembly may for example comprise a sealed drug container and a fluid access device, such as e.g. a double-pointed injection needle, comprising a sealed conduit, and one of the first part and the second part may be operatively coupled with one of the drug container and the fluid access device and configured to cause the fluid access device to establish fluid connection to the drug container in response to the first part and the second part undergoing relative displacement. In case one of the first part and the second part is a protective cap and the other of the first part and the second part comprises a cap receiving portion, the fluid access device may establish fluid connection to the drug container in response to the cap being dismounted from the cap receiving portion.

Further to step (iii) sealing the housing to provide an air-tight medical device may comprise arranging the housing in a separate bag or pouch, and sealing the bag or pouch. Alternatively, or additionally, sealing the housing to provide an air-tight medical device may comprise mounting a gasket, e.g. an O-ring, between the first part and the second part. In case the housing comprises more than two parts sealing the housing to provide an air-tight medical device may comprise mounting respective gaskets between the respective housing parts.

In particular embodiments of the invention a method of manufacturing a fluid transfer device is provided, the method comprising: (i) receiving in a first cleanroom environment categorised by a first airborne particulate cleanliness a) a first container holding a first medium, b) a second container holding a second medium, and c) a fluid connection device adapted to establish fluid communication between the first container and the second container, where each of the first container, the second container and the fluid connection device has been prepared in a second cleanroom environment categorised by a second airborne particulate cleanliness, which is higher than the first airborne particulate cleanliness, and where each of the first container, the second container and the fluid connection device comprises a sealed surface portion, (ii) subsequent to step (i) assembling at least the first container, the second container and the fluid connection device in the first cleanroom environment, thereby providing a sub-assembly, and (iii) subsequent to, or simultaneously with, step (ii) establishing an enclosure for the sub-assembly capable of maintaining an internal airborne particulate cleanliness equivalent to the first airborne particulate cleanliness.

This provides for a fluid transfer device, useable as a mixing device, wherein the first container, the second container, and the fluid connection device are encapsulated in a first local environment characterised by an internal airborne particulate cleanliness equivalent to that of the first cleanroom environment, e.g. first cleanroom, and wherein specific portions of the first container, the second container, and the fluid connection device are fluidly separated from the first local environment and sealed within a second local environment characterised by an internal airborne particulate cleanliness equivalent to that of the cleaner second cleanroom environment, e.g. second cleanroom.

The sealed surface portion of the first container may comprise an interior of the first container, and the first container seal may comprise at least one penetrable cover, e.g. a first penetrable cover. This first penetrable cover may be a first container stopper or plug. Similarly, the sealed surface portion of the second container may comprise an interior of the second container, and the second container seal may comprise at least one penetrable cover, e.g. a second penetrable cover. This second penetrable cover may be a second container stopper or plug. In particular embodiments of the invention the first container is a vial, and the first penetrable cover is a vial stopper, e.g. a rubber plug, while the second container is a syringe, and the second penetrable cover is a syringe stopper, e.g. a rubber plug.

The fluid connection device may comprise one or more hollow spike members defining a flow path. The sealed surface portion of the fluid connection device may comprise the flow path, and the fluid connection device seal may comprise at least one penetrable cover, e.g. a third penetrable cover.

In particular embodiments, the fluid connection device comprises a first hollow spike member defining a first flow path portion, which is sealed by one penetrable cover, and a second hollow spike member defining a second flow path portion, which is fluidly connected to the first flow path portion and sealed by another penetrable cover. The first hollow spike member may comprise a first hollow shaft and the second hollow spike member may comprise a second hollow shaft extending in a different direction from a base section than the first hollow shaft, and the respective penetrable covers may sealingly separate the first and second flow path portions from the surroundings by covering portions of the exterior surfaces, or the entire exterior surfaces, of the first and second hollow shafts.

Step (ii) may comprise arranging the first container, the second container and the fluid connection device so as to enable the fluid connection device to establish fluid connection between the first container and the second container through the respective penetrable covers. This may for example be done by assembling the first container, the second container and the fluid connection device in a serial arrangement in which the flow path is positioned between the first container and the second container. Such an arrangement allows for an easy establishment of fluid communication between the first container and the second container by axial converging displacement of the two.

Specifically, the serial arrangement may comprise a concentric arrangement of the first container, the second container and the fluid connection device such that the first hollow spike member is axially aligned with the first container stopper and the second hollow spike member is axially aligned with the second container stopper. Further, an end portion of the first hollow spike member may be arranged adjacent to the first container stopper (e.g. with the penetrable cover sealing the first flow path portion as an intermediate element), and an end portion of the second hollow spike member may be arranged adjacent to the second container stopper (e.g. with the penetrable cover sealing the second flow path portion as an intermediate element).

Step (iii) may comprise arranging the sub-assembly comprising first container, the second container and the fluid connection device in an at least partially dimensionally stable housing, and sealing the housing to provide an air-tight fluid transfer device. The housing may comprise a first part adapted to at least partially cover the first substance container and a second part adapted to at least partially cover the second substance container. The first part and the second part may be coupled directly or via one or more intermediate parts to form the whole housing. In case the housing comprises multiple parts, at least one of the multiple parts may be dimensionally stable.

The first part and the second part may be displaceable relative to one another. Particularly, the first part may comprise a cover member structured for removable attachment to the second part, or to an intermediate part. Arranging the sub-assembly in an at least partially dimensionally stable housing may include establishing an operative coupling between the sub-assembly and one of the first part and the second part which causes a relative motion between at least two of the first container, the second container and the fluid connection device, e.g. a relative converging motion between the first container and the second container, in response to the first part and the second part being displaced relative to one another during use of the medical device.

In particular embodiments of the invention the sub-assembly further includes a first container holder adapted to support the first container and a second container holder adapted to support the second container, the first container holder comprising first coupling means and the second container holder comprising second coupling means adapted for engagement with the first coupling means to provide for a variable axial positioning of the first container relative to the second container. The first coupling means may e.g. comprise a first helical thread and the second coupling means may e.g. comprise a mating second helical thread. Alternatively, other suitable coupling means may be employed, such as e.g. splines and grooves.

In particular embodiments of the invention the cover member is dimensionally stable and comprises engagement means for operative coupling with the first container. The engagement means may comprise a rigid spline extending axially along at least a portion of the length of the cover member, the spline being adapted for engagement with engagement means, e.g. one or more ratchets, on the first container or on the first container holder so as to prevent rotational motion of the cover member in a specific angular direction relative to the first container or the first container holder. In case the cover member is structured for removable attachment to a cover receiving portion of one of the housing parts via a screw thread connection, the operative coupling between the cover member and the first container may be configured to cause an axial converging motion between the first container and the second container in response to the cover member being unscrewed from the cover receiving portion. This may e.g. be obtained if the screw thread connection comprises a right-hand thread and the first coupling means comprises a left-hand thread, or vice-versa.

Alternatively, an operable portion of the cover member may be movable, e.g. rotatable, relative to another portion of the cover member and may comprise the engagement means for operative coupling with the first container, e.g. via the first container holder, the operative coupling then being configured to cause an axial converging motion between the first container and the second container in response to the operable portion being moved relative to the other portion of the cover member. This may e.g. be obtained by a ratchet and pawl mechanism ensuring joint rotational motion in a certain direction of the operable portion and the first container holder.

Such a construction enables an operation of the sub-assembly from outside the housing, e.g. in connection with, or before, a removal of the cover member from the remaining parts of the device. The axial converging motion of the first container and the second container may therefore lead to an establishment of fluid communication between the first container interior and the second container interior via the flow path defined by the fluid connection device before exposure of the sub-assembly to the free surroundings.

The above described fluid transfer device thus allows for mixing of substances within a closed local environment characterised, generally, by an airborne particulate cleanliness which is higher than that of the free surroundings and, specifically, for the essential areas that constitute the fluid flow path, an airborne particulate cleanliness which honours the desire for low risk of fluid contamination. Notably, the manufacturing expenditure associated with this fluid transfer device is relatively low due to the minimised use of high grade cleanroom resources.

Step (iii) may alternatively comprise placing a cap structure over at least a portion of the sub-assembly and hermetically sealing the at least a portion of the sub-assembly within the cap structure, e.g. using one or more gaskets.

Placing the cap structure over the at least a portion of the sub-assembly may include establishing an operative coupling between the cap structure and the sub-assembly which causes a relative motion between at least two of the plurality of medical components in response to the cap structure and one of the plurality of medical components being displaced relative to one another during use of the medical device. This will allow operation of the sub-assembly without a reduction of the airborne particulate cleanliness within the cap structure.

In particular embodiments of the invention a method of manufacturing a medical device is provided, the method comprising: (i) receiving in a first cleanroom environment categorised by a first airborne particulate cleanliness a) a drug container comprising a variable volume chamber, and b) a fluid access device adapted to establish fluid connection to the variable volume chamber, where each of the drug container and the fluid access device has been prepared in a second cleanroom environment categorised by a second airborne particulate cleanliness, which is higher than the first airborne particulate cleanliness, and where each of the drug container and the fluid access device comprises a sealed surface portion, (ii) subsequent to step (i) assembling at least the drug container and the fluid access device in the first cleanroom environment, thereby providing a sub-assembly, and (iii) subsequent to, or simultaneously with, step (ii) placing a cap structure over at least a portion of the sub-assembly and hermetically sealing the at least a portion of the sub-assembly within the cap structure.

The drug container may further comprise an outlet portion which is sealed by a penetrable, e.g. self-sealing, septum, and the fluid access device may be adapted to establish fluid connection to the variable volume chamber through the septum. Step (iii) may thus comprise hermetically sealing at least the septum and the fluid access device within the cap structure.

The fluid access device may comprise piercing means for penetration of the septum. Placing the cap structure over the at least a portion of the sub-assembly may include establishing an operative coupling between the cap structure and the sub-assembly which causes the piercing means to penetrate the septum in response to a relative displacement between the cap structure and the drug container. Thereby, fluid connection can be established between the fluid access device and the drug container without compromising the sealed environment provided for the septum and the fluid access device.

The drug container may be a drug cartridge arranged in a cartridge holder, the drug cartridge comprising a displaceable piston, and the operative coupling between the cap structure and the sub-assembly may cause the piercing means to penetrate the septum in response to a relative displacement between the cap structure and the cartridge holder.

The fluid access device may further comprise a Luer connector and a conduit fluidly connecting the Luer connector and the piercing means. The Luer connector may be sealingly covered by a fitting piece, which fitting piece is removable either simultaneously with or subsequent to a dismounting of the cap structure from the sub-assembly. This enables swift and easy attachment of an infusion set (or the like) after removal of the cap structure without the user needing to use alcohol swabs to manually clean any surfaces. The drug cartridge may be coupled with a drug expelling mechanism comprising a piston actuator, in which case an operation of the drug expelling mechanism subsequent to attachment of an infusion set may lead to immediate delivery of the drug through the fluid access device and the infusion set.

The method according to the present invention is particularly suitable for the manufacturing of a medical device comprising an assembly wherein one or more constituents cannot undergo sterilisation without a risk of degradation, precluding the assembly itself from being sterilised.

In the present specification, reference to a certain aspect or a certain embodiment (e.g. “an aspect”, “a first aspect”, “one embodiment”, “an exemplary embodiment”, or the like) signifies that a particular feature, structure, or characteristic described in connection with the respective aspect or embodiment is included in, or inherent of, at least that one aspect or embodiment of the invention, but not necessarily in/of all aspects or embodiments of the invention. It is emphasized, however, that any combination of the various features, structures and/or characteristics described in relation to the invention is encompassed by the invention unless expressly stated herein or clearly contradicted by context.

The use of any and all examples, or exemplary language (e.g., such as, etc.), in the text is intended to merely illuminate the invention and does not pose a limitation on the scope of the same, unless otherwise claimed. Further, no language or wording in the specification should be construed as indicating any non-claimed element as essential to the practice of the invention.

### BRIEF DESCRIPTION OF THE DRAWINGS

In the following the invention will be further described with references to the drawings, wherein

FIG. 1 is a schematic view of a medical manufacturing process according to prior art,

FIG. 2 is a schematic view of a method for manufacturing a medical device according to an embodiment of the invention,

FIGS. 3-5 are schematic views of exemplary process steps for individual medical components,

FIG. 6 is a longitudinal section view of a medical device manufactured by use of a method according to an embodiment of the invention,

FIG. 7 is a close-up perspective view of a mechanical coupling between an enclosure and a sub-assembly of the medical device, and

FIG. 8 is a longitudinal section view of a portion of another medical device manufactured by use of a method according to an embodiment of the invention.

In the figures like structures are mainly identified by like reference numerals.

### DESCRIPTION OF EXEMPLARY EMBODIMENTS

When in the following relative expressions, such as “upwards” and “downwards”, are used, these refer to the appended figures and not necessarily to an actual situation of use. The shown figures are schematic representations for which reason the configuration of the different structures as well as their relative dimensions are intended to serve illustrative purposes only.

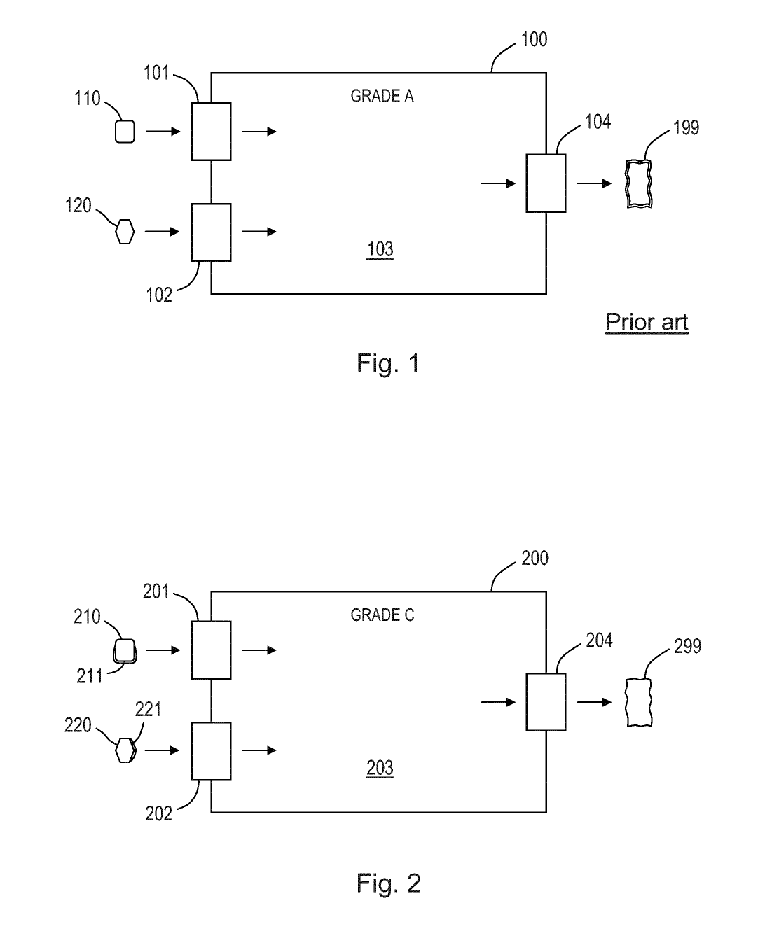

FIG. 1 shows schematically a conventional process for the manufacturing of a medical device requiring a certain level of asepsis. Different components 110, 120 for the device are pretreated, e.g. sterilised, in entry sections 101, 102 for a cleanroom environment 100 and enter a Grade A cleanroom 103 capable of maintaining an acceptably high airborne particulate cleanliness. In the cleanroom 103 the components 110, 120 are assembled and otherwise handled to produce a final device 199 which is then enclosed in a sterile packaging before leaving via an exit section 104, to thereby provide an internal particulate environment equivalent to that of the cleanroom 103.

Assembly, handling and packaging of device components in the cleanroom environment 100 is expensive. Hence, a minimisation of use of a cleanroom environment of this category is desirable.

FIG. 2 shows schematically a method of manufacturing a medical device according to an embodiment of the invention. The medical device is of the same type as the one described in connection with FIG. 1. By this method a first component 210 and a second component 220, both having been prepared, e.g. sterilised, and having had respective surface portions 211, 221 sealed in a Grade A cleanroom, enter a cleanroom environment 200 of lower classification through respective entry sections 201, 202. In this particular embodiment cleanroom environment 200 is represented by a Grade C cleanroom 203, characterised by an airborne particulate cleanliness which is approximately 1000 times lower than that of the Grade A cleanroom. The two components 210, 220 are assembled to form a sub-assembly and subsequently arranged in an enclosure capable of maintaining an internal particulate environment equivalent to that of the cleanroom 203.

The sub-assembly and the enclosure together constitute the medical device product 299, which upon leaving the cleanroom 203 via an exit section 204 comprises certain sealed portions providing respective internal particulate environments equivalent to that of a Grade A cleanroom and remaining sealed portions providing respective internal particulate environments equivalent to that of a Grade C cleanroom. Thereby, the entire device product 299 may be less clean than the device 199 manufactured by way of the above described prior art method, but specific portions of the device product 299 are just as clean, and this may be obtained at a fraction of the cost for producing the other device 199.

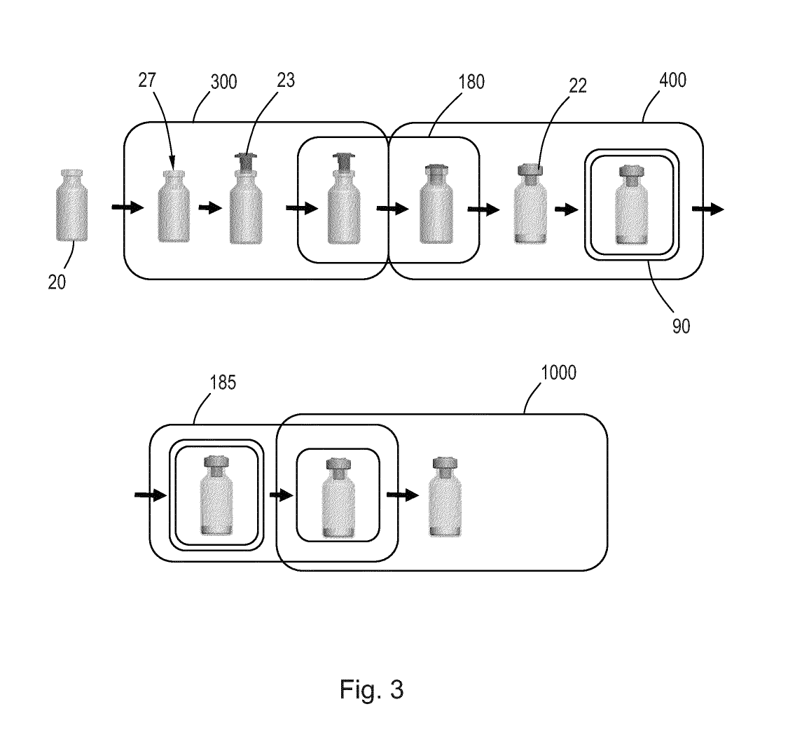

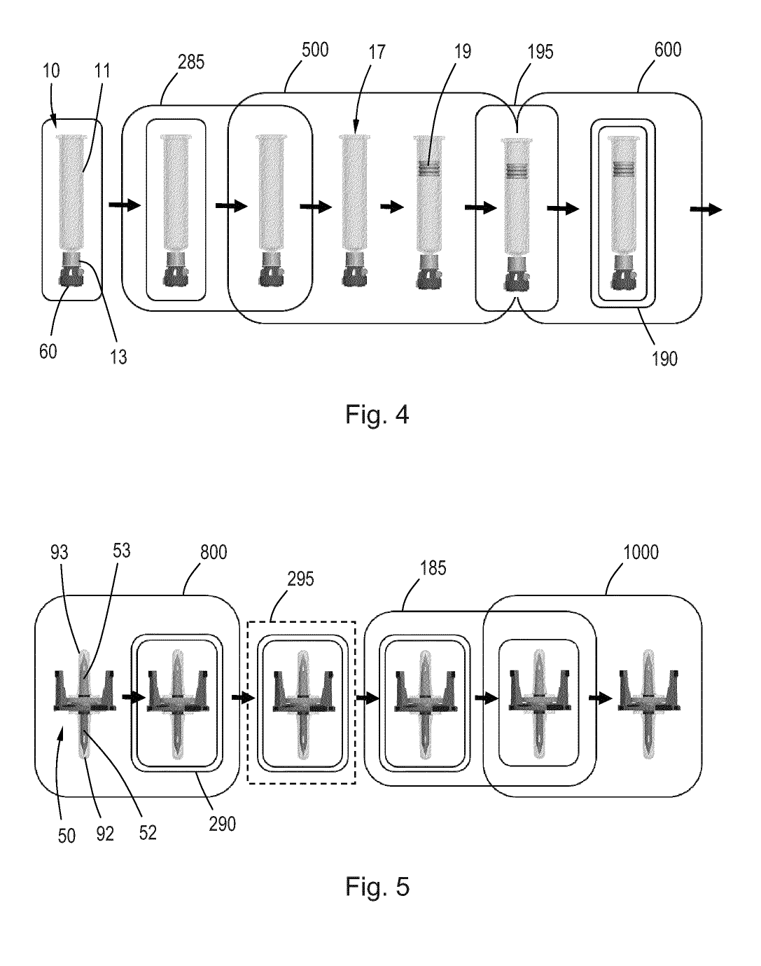

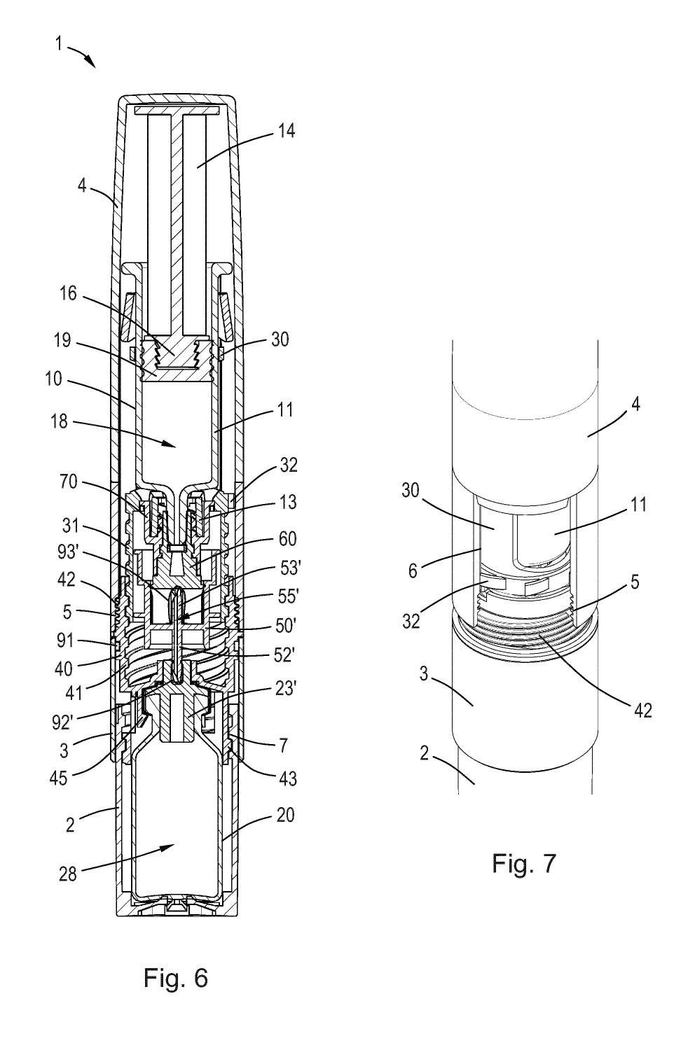

FIGS. 3-5 show the process steps for three components, respectively a vial 20 (FIG. 3), a syringe reservoir 10 (FIG. 4), and a connector piece 50 (FIG. 5), for a medical mixing device 1 (depicted in FIG. 6) manufactured by a method according to an embodiment of the invention.

Referring to FIG. 3, the vial 20 is sterilised and enters a Grade A cleanroom 300, where it is filled with a medicament on liquid form through an opening 27. A vial stopper 23 is subsequently placed in the opening 27, leaving space for transport of gas therethrough, and the vial 20 enters a freeze dryer 180 in which the liquid is lyophilised to produce a powdered medicament. Then the vial stopper is manipulated to seal the vial 20 properly, thereby maintaining an internal particulate environment equivalent to that of the cleanroom 300, and the sealed vial 20 enters a Grade C cleanroom 400, where it is provided with a seal cap 22 and arranged in a dual layer packaging 90 capable of maintaining an internal particulate environment equivalent to that of the cleanroom 400. The packed vial 20 then leaves the cleanroom 400 and is transported under non-classified conditions, e.g. on a truck bed, to a different manufacturing site, where it enters an airlock 185. The vial 20 is unpacked and from the airlock 185 it enters a Grade C cleanroom 1000, which is the area of final assembly.

Referring to FIG. 4, the syringe reservoir 10, comprising a barrel 11, a Luer collar 13, and a syringe stopper 60, enters an airlock 285 in a sterile packaging. Following unpacking the syringe reservoir 10 enters a Grade A cleanroom 500, where it is filled with a solvent through a rear opening 17 and sealed by a rubber piston 19. The sealed syringe reservoir 10 then enters an autoclave 195 and is sterilised. Following sterilisation the syringe reservoir 10 enters a Grade C cleanroom 600, where it is arranged in a dual layer packaging 190 capable of maintaining an internal particulate environment equivalent to that of the cleanroom 600. The packed syringe reservoir 10 then leaves the cleanroom 600 and is transported to the area of final assembly.

Referring to FIG. 5, the connector piece 50 comprises a first hollow spike shaft 52 and a second hollow spike shaft 53 defining a flow channel and having respective sharpened end portions capable of penetrating barrier elements, such as e.g. rubber septa. Each of the spike shafts 52, 53 is provided with a soft sealing cover 92, 93 that covers its entire surface. The sealing covers 92, 93 may, however, alternatively cover the spike shafts 52, 53 only partially, as long as the flow channel is sealed from the open surroundings.

The connector piece 50 is assembled in a Grade C cleanroom 800 and arranged in a sealing dual layer packaging 290 before leaving for radiation sterilisation 295, e.g. E-beam or Gamma sterilisation. Following the sterilisation process the connector piece 50 enters the airlock 185, where it is unpacked, and subsequently the cleanroom 1000 for final assembly.

In the cleanroom 1000 the vial 20, the syringe reservoir 10 and the connector piece 50 are then arranged to form a sub-assembly suitable for use in the mixing device 1. The vial 20 thus comprises a sealed aseptic interior holding a lyophilised drug, the syringe reservoir 10 comprises a sealed aseptic interior holding a solvent, and the connector piece 50 comprises a sealed aseptic flow channel.

In the above described embodiment the vial 20, the syringe reservoir 10, and the connector piece 50 are prepared in different cleanrooms before being transported to the area of final assembly. It is clear, however, that some or all of these components may alternatively be prepared in the same cleanroom or in neighbouring cleanrooms and from there directly enter into the cleanroom 1000 without intermediate transportation.

FIG. 6 shows a longitudinal section view of the mixing device 1 comprising the above described sub-assembly in a slightly alternative version because the vial 20 is sealed by a vial stopper 23′ of different design than the vial stopper 23, and because the connector piece 50 is replaced by a connector piece 50′ having a different configuration. The mixing device 1 is adapted for reconstitution of a powdered drug in a vial interior 28 using a solvent initially contained in a syringe interior 18, and it is shown in the assembled state prior to a first use thereof.

The vial 20 is arranged in a protective vial support 2, made of a transparent plastic or other suitable material. A lock ring 3 is fitted over a portion of the vial support 2 and locked against rotation relative to the vial support 2 via a longitudinal internal rib (not visible) engaging a longitudinal groove (not visible) in the outer surface of the vial support 2. The lock ring 3 is connected to a coupling element 40 via a cam 91 on the interior surface of the lock ring 3 and a cam receiving bayonet groove (not visible) in an exterior surface of the coupling element 40.

The coupling element 40 comprises a tubular sleeve which further has an exterior thread 43 at its distal end portion for engagement with an interior thread 7 in the vial support 2, and an interior thread 41 at its proximal end portion for engagement with an exterior thread 31 of a syringe holder 30. The coupling element 40 also has an exterior thread 42 arranged proximally of the exterior thread 43 and a number of circumferentially spaced apart catch arms 45 extending downwards from a transversal portion at the end of the interior thread 41 for securing firm attachment of the vial 20.

The syringe holder 30 has a proximal portion adapted to receive a portion of the syringe reservoir 10, and a distal portion which carries the exterior thread 31 and which is designed to accommodate and support at least a portion of the connector piece 50′, e.g. by a friction fit. A number of ratchet arms 32 are arranged equidistantly along the circumference of a central portion of the syringe holder 30. The syringe reservoir 10 is releasably connected to the syringe holder 30 via a threaded engagement between the Luer collar 13 and a stopper fastener 70 being both translationally and rotationally locked to the syringe holder 30. A piston rod 14 is coupled firmly to the piston 19 via a jagged coupling head 16.

The connector piece 50′ is slidably received in the hollow interior of the distal portion of the syringe holder 30. A sleeve body supports a transverse spike base which carries a distally pointing hollow spike member 52′ as well as a proximally pointing hollow spike member 53′. The two hollow spike members 52′, 53′ together define a lumen 55′ which serves as a fluid flow path. The entire hollow spike member 53′ is covered by a penetrable sealing membrane 93′, and the tip portion of the hollow spike member 52′ is covered by a penetrable sealing membrane 92′, whereby the lumen 55′ is encapsulated.

In the depicted state of the mixing device 1 the hollow spike member 53′ is arranged just distally of the syringe stopper 60 and the hollow spike member 52′ is arranged just proximalty of the vial stopper 23′. The syringe reservoir 10 and the vial 20 are therefore fluidly unconnected at this point.

A cap 4 is arranged to cover the piston rod 14 and a portion of the syringe reservoir 10 during storage and transportation of the mixing device 1 to prevent operation of the piston rod 14 and thereby to ensure that pressure is not prematurely applied to the contents of the syringe reservoir 10. The cap 4 has an interior thread 5 adapted to engage with the exterior thread 42 for positioning of the cap 4 relative to the coupling member 40.

In the present embodiment the cap 4, the lock ring 3, and the vial support 2 constitute a housing for the sub-assembly comprising the syringe reservoir 10 (with the piston rod 14), the syringe holder 30, the connector piece 50′, the vial 20, and the coupling element 40.

FIG. 7 is a close-up perspective view of a portion of the mixing device 1 showing an operative coupling between the cap 4 and the syringe reservoir 10. For the sake of clarity a portion of the cap 4 has been cut away to reveal the engagement of one of the ratchet arms 32 with one of a number of axially extending ribs 6 arranged on interior surface portions of the cap 4. This ratchet mechanism provides for a unidirectional rotational coupling between the cap 4 and the syringe holder 30, ensuring that the cap 4 and the syringe holder 30 are locked against relative rotation during unscrewing of the cap 4 from the exterior thread 42. When the cap 4 is turned in the counter-clockwise direction the ribs 6 will slave the syringe holder 30, and thereby the syringe reservoir 10, whereas when the cap 4 is turned in the clockwise direction the ribs 6 will ride over the ratchet arms 32, enabling relative rotational movement between the cap 4 and the syringe holder 30 as the cap 4 is screwed onto the exterior thread 42.

The exterior thread 42 is a right-hand thread and the interior thread 41 is a left-hand thread (or vice-versa), so when the cap 4 is unscrewed from the exterior thread 42, and the cap 4 thereby is moved axially away from the coupling element 40, the exterior thread 31 is screwed further into the interior thread 41, whereby the syringe holder 30 is moved axially in the opposite direction towards the vial 20, while the ratchet arms 32 slide along the ribs 6. The converging relative motion between the syringe reservoir 10 and the vial 20 thereby induced will eventually cause the hollow spike member 53′ to penetrate the sealing membrane 93′ and the syringe stopper 60 and the hollow spike member 52′ to penetrate the sealing membrane 92′ and the vial stopper 23′ to establish proper fluid communication between the syringe interior 18 and the vial interior 28.

Gaskets in the form of O-rings (not visible) are provided between the various parts of the housing to seal the interior of the mixing device 1. This is done before the mixing device 1 leaves the cleanroom 1000, whereby it is ensured that the sub-assembly is contained in an environment having an internal airborne particulate cleanliness corresponding to that of the cleanroom 1000. The operative coupling between the cap 4 and the syringe reservoir 10 and the threaded connection between the syringe holder 30 and the coupling element 40 which cause the hollow spike member 53′ to penetrate the sealing membrane 93′ and the syringe stopper 60 and the hollow spike member 52′ to penetrate the sealing membrane 92′ and the vial stopper 23′ during unscrewing of the cap from the exterior thread 42 thus provides for an automatic establishment of fluid communication between the aseptic syringe interior 18 and the aseptic vial interior 28 through the aseptic lumen 55′ in local surroundings having an airborne particulate cleanliness corresponding to a Grade C cleanroom level, i.e. in a much cleaner environment than the open surroundings.

The risk of contamination of the substances as a consequence of a manual handling is thereby eliminated since when the cap 4 has been completely removed from the coupling element 40 the piston rod 14 can be operated to firstly cause a transfer of the solvent from the syringe interior 18 to the vial interior 28 through the lumen 55′ and subsequently cause a transfer of the reconstituted drug in the opposite direction from the vial interior 28 to the syringe interior 18 without any intermediate interruption of the closed flow path between the syringe interior 18 and the vial interior 28. Once the reconstituted drug has been transferred to the syringe interior 28 the syringe reservoir 10 can be removed from the syringe holder 30 and used for administration of the drug.

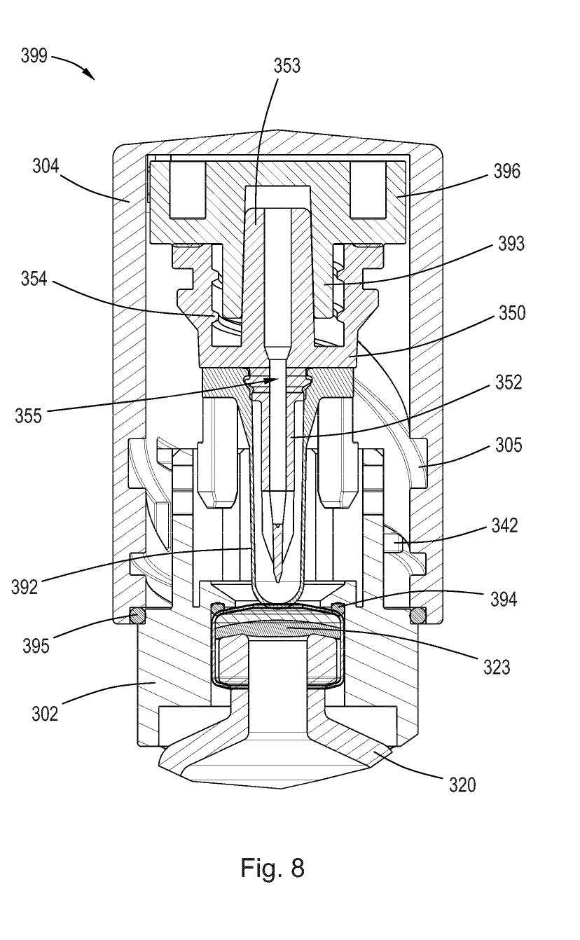

FIG. 8 shows a distal portion of a drug delivery device 399, specifically the shoulder and neck portions of a drug containing cartridge 320, which is being held in a cartridge holder 302 (of which only the distal most portion is shown), a connector piece 350, and a cap 304. The interior of the cartridge 320 is hermetically sealed from the surroundings by a proximal, slidable piston (not shown) and a penetrable self-sealing rubber septum 323. The connector piece 350 comprises a proximally pointing spike shaft 352 configured to penetrate the septum 323, a distally pointing Luer connector 353, and a threaded collar 354 surrounding a portion of the Luer connector 353. A lumen 355 extends through the connector piece 350 and fluidly connects the proximal end portion of the spike shaft 352 with the Luer connector 353. The spike shaft 352 is surrounded by a sealing cover 392 in a fluid tight manner, and the Luer connector is sealingly surrounded by a fitting piece 396 having a tight fitting extension 393, the sealing cover 392 and the fitting piece 396 thereby providing a fluid sealing for the lumen 355. A gasket 395 is provided between the cap 304 and the cartridge holder 302 and another gasket 394 is provided between the cartridge holder 302 and the top of the cartridge 320 to hermetically seal the septum 323 and the connector piece 350 from the surroundings.

An interior wall portion of the cap 304 is provided with a helical track 305 adapted to guide a protrusion 342 on the cartridge holder 302 during operation of the drug delivery device 399.

The cartridge 320 is sterilised, filled and sealed in a Grade A cleanroom. Further, the connector piece 350 is sterilised and the lumen 355 is sealed by the sealing cover 392 and the fitting piece 396 in a Grade A cleanroom. Subsequently, the cartridge 320 and the connector piece 350 with the sealing cover 392 and the fitting piece 396 enter a Grade C cleanroom facility in which they are assembled and sealingly covered by means of the cap 304 and the gaskets 394, 395. This provides an interior environment for the assembly which is equivalent to the environment in the Grade C cleanroom, while sterility is preserved for the cartridge interior and the lumen 355 which constitutes a part of the fluid pathway during a drug administration.

In use a rotation of the cap 304 relative to the cartridge holder 302 causes the protrusion 342 to travel the helical track 305, whereby the cap 304 is forced downwards, pushing the fitting piece 396 and the connector piece 350 in the same direction for eventual penetration of the sealing cover 392 and the septum 323 by the spike shaft 352, and, consequently, establishment of fluid connection to the interior of the cartridge 320. A subsequent dismounting of the cap 304 from the cartridge holder 302 exposes the fitting piece 396 which can be manually removed to enable attachment of an infusion set (not shown) to the Luer connector 353. By advancement of the piston in the cartridge 320 (manual or automatic advancement, as well known in the art) the drug is delivered through the lumen 355 and the infusion set to a desired administration site.

1. A method of manufacturing a medical device, the method comprising:
receiving in a first cleanroom environment categorised by a first airborne particulate cleanliness a plurality of medical components prepared in a second cleanroom environment categorised by a second airborne particulate cleanliness, which is higher than the first airborne particulate cleanliness, where each of the plurality of medical components comprises a sealed surface portion,
assembling at least the plurality of medical components in the first cleanroom environment, thereby providing a sub-assembly, and
establishing an enclosure for the sub-assembly capable of maintaining an internal airborne particulate cleanliness equivalent to the first airborne particulate cleanliness.

2. A method according to claim 1, wherein the second cleanroom environment is an aseptic environment and the first cleanroom environment is a non-aseptic environment.

3. A method according to claim 1, wherein the second airborne particulate cleanliness is at least 1000 times higher than the first airborne particulate cleanliness.

4. A method according to claim 1, wherein the establishing step comprises arranging the sub-assembly in an at least partially dimensionally stable housing, and sealing the housing to provide an air-tight medical device.

5. A method according to claim 4, wherein sealing the housing to provide an air-tight medical device comprises arranging the housing in a pouch and sealing the pouch.

6. A method according to claim 4, wherein the housing comprises a first part and a second part, the first part and the second part being displaceable relative to one another.

7. A method according to claim 6, wherein the first part comprises a cover member structured for removable attachment to the second part.

8. A method according to claim 6, wherein arranging the sub-assembly in an at least partially dimensionally stable housing includes establishing an operative coupling between the sub-assembly and one of the first part and the second part which causes a relative motion between at least two of the plurality of medical components in response to the first part and the second part being displaced relative to one another during use of the medical device.

9. A method according to claim 6, wherein sealing the housing to provide an air-tight medical device comprises mounting a gasket between the first part and the second part.

10. A method according to claim 1, further comprising preparing the plurality of medical components in the second cleanroom environment prior to the receiving step, the preparation comprising sterilising and sealing a surface portion of each of the plurality of medical components.

11. A method according to claim 1, wherein the medical device is a mixing device, and wherein the plurality of medical components comprises a first substance container, a second substance container, and a fluid connection device adapted to establish fluid connection between the first substance container and the second substance container during use of the mixing device.

12. A method according to claim 11, wherein the sealed surface portion of the first substance container comprises an interior of the first substance container sealed by at least one penetrable cover, the sealed surface portion of the second substance container comprises an interior of the second substance container sealed by at least one other penetrable cover, and the sealed surface portion of the fluid connection device comprises a flow path sealed by at least one further penetrable cover.

13. A method according to claim 12, wherein the assembling step comprises arranging the first substance container, the second substance container, and the fluid connection device so as to enable the fluid connection device to establish fluid connection between the first substance container and the second substance container through the respective penetrable covers.

14. A method according to claim 13, wherein the establishing step comprises arranging the first substance container, the second substance container, and the fluid connection device in a series in which the flow path is positioned between the first substance container and the second substance container.

15. A method according to claim 14, wherein the flow path is defined by a first hollow spike member and a second hollow spike member, and wherein the assembling step comprises arranging the first substance container, the second substance container, and the fluid connection device concentrically such that the first hollow spike member is axially aligned with the at least one penetrable cover sealing the first substance container, and the second hollow spike member is axially aligned with the at least one other penetrable cover sealing the second substance container.

16.-19. (canceled)
